(19) United States
(12) Patent Application Publication
(10) Pub. No.: US 2010/0067231 A1
(43) Pub. Date: Mar. 18, 2010

(54) LED-BASED LIGHT HAVING RAPIDLY OSCILLATING LEDS

(75) Inventors: David L. Simon, Grosse Pointe Woods, MI (US); John Ivey, Farmington Hills, MI (US)

Correspondence Address: YOUNG BASILE, 3001 WEST BIG BEAVER ROAD, SUITE 624, TROY, MI, 48084, US

(73) Assignee: Altair Engineering, Inc., Troy, MI (US)

(21) Appl. No.: 12/210,653

(22) Filed: Sep. 15, 2008

(51) Int. Cl. F21V 21/00

(52) U.S. Cl. 362/249.03

(57) ABSTRACT

An LED-based light includes a support structure. At least one oscillator is connected to the support structure. At least one LED is coupled to each oscillator. The oscillator can oscillate the LED to produce a light blurring effect.

### TECHNICAL FIELD

The invention relates to a light emitting diode (LED) based light, for example, an LED-based light usable in a fluorescent light fixture in place of a conventional fluorescent tube.

### BACKGROUND

Fluorescent tubes are widely used in a variety of locations, such as schools and office buildings. Although conventional fluorescent tubes have certain advantages over, for example, incandescent lights, they also pose certain disadvantages including, inter alia, disposal problems due to the presence of toxic materials within the glass tube.

Tube shaped LED lights which can be used as one-for-one replacements for fluorescent tubes have appeared in recent years. Many LED-based lights shaped to replace fluorescent tubes are constrained by the directional light output of their LEDs, in contrast to the uniform non-directional light output of fluorescent tubes.

### BRIEF SUMMARY

Oscillating an LED can reduce the appearance of point sources of light by producing a light blurring effect. In one example, an LED-based light is provided including a support structure, at least one oscillator connected to the support structure, and at least one LED coupled to each oscillator.

In another example, a replacement light for a conventional fluorescent tube usable in a fluorescent fixture is provided. The replacement light includes a support structure and at least one oscillator connected to the support structure. At least one LED is coupled to each oscillator, and at least one electrical connector at a longitudinal end of the support structure is in electrical communication with the at least one LED.

In yet another example, a method of distributing light produced by LEDs in an LED-based light usable in a fluorescent fixture is provided. The method includes providing at least one microelectromechanical system. The method also includes connecting the LEDs to the at least one microelectromechanical system and energizing the at least one microelectromechanical system during operation of the LEDs to move the LEDs at a sufficient speed to produce a light blurring effect.

### BRIEF DESCRIPTION OF THE DRAWINGS

The description herein makes reference to the accompanying drawings wherein like reference numerals refer to like parts throughout the several views, and wherein:

FIG. 1 is an exploded schematic of an example of an LED-based replacement light;

FIG. 2 is a schematic of an example of an oscillator;

FIGS. 3A and 3B are a cross section view with LEDs in a first position and a partial cross section view with the LEDs in a second position, respectively, of the light of FIG. 1 along line A-A;

FIG. 4 is a partial cross section view the light of FIG. 1 along light A-A showing a distribution of light produced by the LEDs during oscillation, with the LED in the second position shown in phantom;

FIG. 5 is a partial schematic of another example of an oscillator;

FIGS. 6A and 6B are end views of a housing of an example of an LED-based light including the oscillator of FIG. 5;

FIG. 7 is an end view of the housing of FIGS. 6A and 6B showing a distribution of light produced by the LEDs during oscillation;

FIG. 8 is a partial schematic of yet another example of an oscillator; and

FIG. 9 is a partial perspective view of a flashlight.

### DETAILED DESCRIPTION

FIGS. 1-9 illustrate examples of LED-based lights. In the example illustrated in FIG. 1, a light 10 is configured as a replacement for a fluorescent tube in a fluorescent fixture. The light 10 includes a housing 12, a circuit board 16 in the housing 12, multiple microelectromechanical systems (MEMS) 18 spaced along the circuit board 16, an LED 20 attached to each MEMS 18, and two bi-pin end caps 22.

The housing 12 as shown in FIG. 1 is a light transmitting cylindrical tube. The housing 12 can be made from polycarbonate, acrylic, glass or another light transmitting material (i.e., the housing 12 can be transparent or translucent). For example, a translucent housing 12 can be made from a composite, such as polycarbonate with particles of a light refracting material interspersed in the polycarbonate. While the illustrated housing 12 is cylindrical, the housing 12 can alternatively have a square, triangular, polygonal, or other cross sectional shape. Similarly, while the illustrated housing 12 is linear, the housing 12 can have an alternative shape, e.g., a U-shape or a circular shape. Additionally, the housing 12 need not be a single piece as shown in FIG. 1. Instead, the housing 12 can be formed by attaching multiple individual parts, not all of which need be light transmitting. For example, the housing 12 can include a lower portion and a lens attached to the lower portion to cover the LEDs 20. The housing 12 can be manufactured to include light diffusing or refracting properties, such as by surface roughening or applying a diffusing film to the housing 12. The housing 12 can have a length such that the light 10 is approximately 48″ long, and the housing 12 can have a 0.625″, 1.0″, or 1.5″ diameter for engagement with common fluorescent fixtures.

The circuit board 16 as illustrated in FIG. 1 is an elongate printed circuit board. Multiple circuit board sections can be joined by bridge connectors to create the circuit board 16. The circuit board 16 as shown in FIG. 1 is slidably engaged with the housing 12, though the circuit board 16 can alternatively be clipped, adhered, snap- or friction-fit, screwed or otherwise connected to the housing 12. For example, the circuit board 16 can be mounted on a heat sink that is attached to the housing 12. Also, other types of circuit boards may be used, such as a metal core circuit board. Or, instead of a circuit board 16, other types of electrical connections (e.g., wires) can be used to electrically connect the MEMS 18 and/or LEDs 20 to a power source.

The LEDs 20 can be surface-mount devices of a type available from Nichia, though other types of LEDs can alternatively be used. For example, although surface-mounted LEDs 20 are shown, one or more organic LEDs can be used in place of or in addition thereto. The LEDs 20 can be mounted to the MEMS 18 as described above. The LEDs 20 can emit white light. However, LEDs that emit blue light, ultra-violet light or other wavelengths of light can be used in place of white light emitting LEDs 20.

The number of LEDs 20 can be a function of the desired power of the light 10 and the power of the LEDs 20. For a 48″ light, such as the light 10, the number of LEDs 20 can vary from about five to four hundred such that the light 10 outputs approximately 500 to 3,000 lumens. However, a different number of LEDs 20 can alternatively be used, and the light 10 can output another amount of lumens. The LEDs 20 can be evenly spaced along the circuit board 16, and the spacing of the LEDs 20 can be determined based on, for example, the light distribution of each LED 20 and the number of LEDs 20.

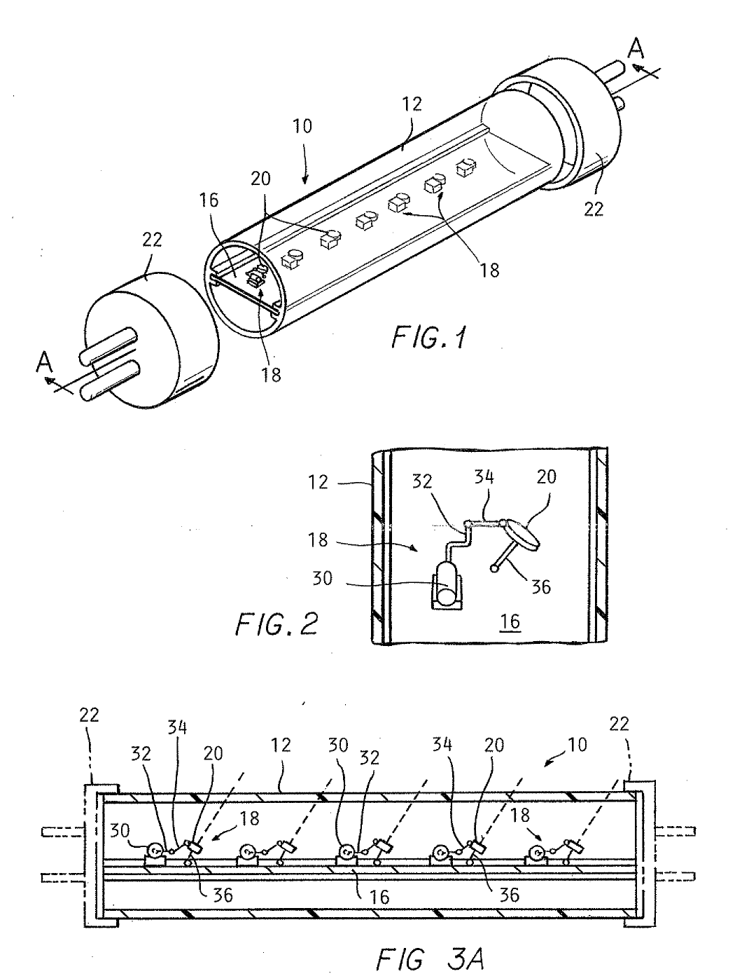

As shown in FIG. 2, the MEMS 18 can include a motor 30, a cam 32, a link 34, and a lever 36. The motor 30 can be in electrical communication with the end caps 22. Alternatively, the motor 30 can be powered by another power source, e.g., a battery. The motor 30 can be a variable speed motor. The cam 32 can be coupled to the motor 30, either directly or through a transmission. The link 34 can couple the cam 32 to the lever 36, with opposing ends of the link 34 pivotally coupled to the cam 32 and lever 36 respectively. The lever 36 can be pivotally coupled to the circuit board 16. An LED 20 can be attached to the distal end of the lever 36, for example by adhering the LED 20 to the lever 36 or a snap-fit between the LED 20 and a platform at the distal end of the lever 36. However, the lever 36 and LED 20 can alternatively be attached to a support structure other than the circuit board 16, such as the housing 12, a heat sink, or a beam extending through the housing 12.

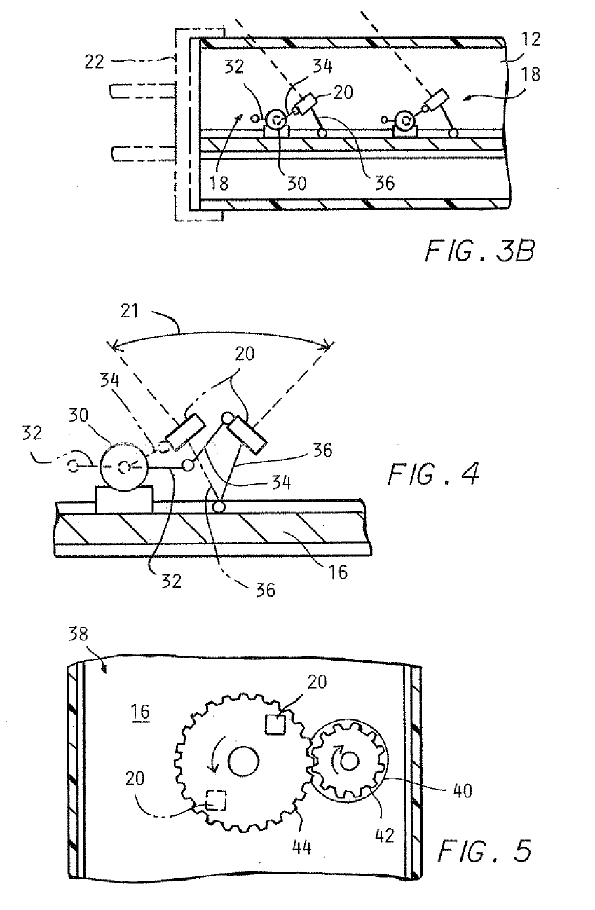

During operation, a current can be applied to the motor 30 to operate the motor 30 and rotate the cam 32. Rotation of the cam 32 can be transmitted to the lever 36 via the link 34. As a result, the distal end of the lever 36 can be oscillated between a first position shown in FIG. 3A and a second position as shown in FIG. 3B. The LEDs 20 can thus be oscillated parallel to a longitudinal axis of the housing 12, as obtaining a uniform distribution of light from LEDs 20 along a length of the housing 12 is often more difficult than obtaining a uniform distribution of light around an arc of the housing 12. However, the LEDs 20 can be oscillated in a different direction, e.g., perpendicular to the longitudinal axis of the housing 12. Also, the LEDs 20 can be oscillated to another position in addition to the first and second positions, e.g., the LEDs 20 can be oscillated in an L-shaped pattern including three positions or in a circular pattern as described in another example below including an infinite number of positions.

The speed of the motor 30 can be set high enough such that the LED 20 moves at a sufficiently rapid speed to produce a light blurring effect. That is, the LED 20 can be moved at a sufficiently high speed such that a human eye perceives the LED 20 as producing a larger distribution of light than if the LED 20 were stationary. Thus, by mounting the light on the MEMS 18 as shown in FIG. 2, the LED 20 can appear as a line of light 21 as shown in FIG. 4 extending between the LED 20 in the first position and the LED 20 shown in phantom in the second position.

Regarding the MEMS 18, structures are generally classified as microelectromechanical systems based on their size. For example, a structure smaller than a few millimeters in size (e.g., a structure less than a millimeter in length) can be deemed a microelectromechanical system. However, as used herein, the term “microelectromechanical system” is not intended to require any specific size limitation. That is, no bright line is intended between a structure that is small enough to be considered a microelectromechanical system and a structure that is not considered a microelectromechanical system. Instead, the term “microelectromechanical system” refers to a system having a size of similar magnitude to the size of the LED 20 attached thereto or smaller.

The light 10 can include two bi-pin end caps 22 (i.e., each end cap 22 can carry two pins), one at each longitudinal end of the housing 12, for physically and electrically connecting the light 10 to a fluorescent fixture. The end caps 22 can be electrically connected to the circuit board 16 to provide power to the MEMS 18 and LEDs 20. Each end cap 22 can include two pins, though two of the total four pins can be “dummy pins” that do not provide an electrical connection. Alternatively, other types of electrical connectors can be used, such as an end cap carrying a single pin. Also, while the end caps 22 are shown as including cup-shaped bodies, the end caps 22 can have a different configuration (e.g., the end caps 22 can be shaped to be press fit into the housing 12).

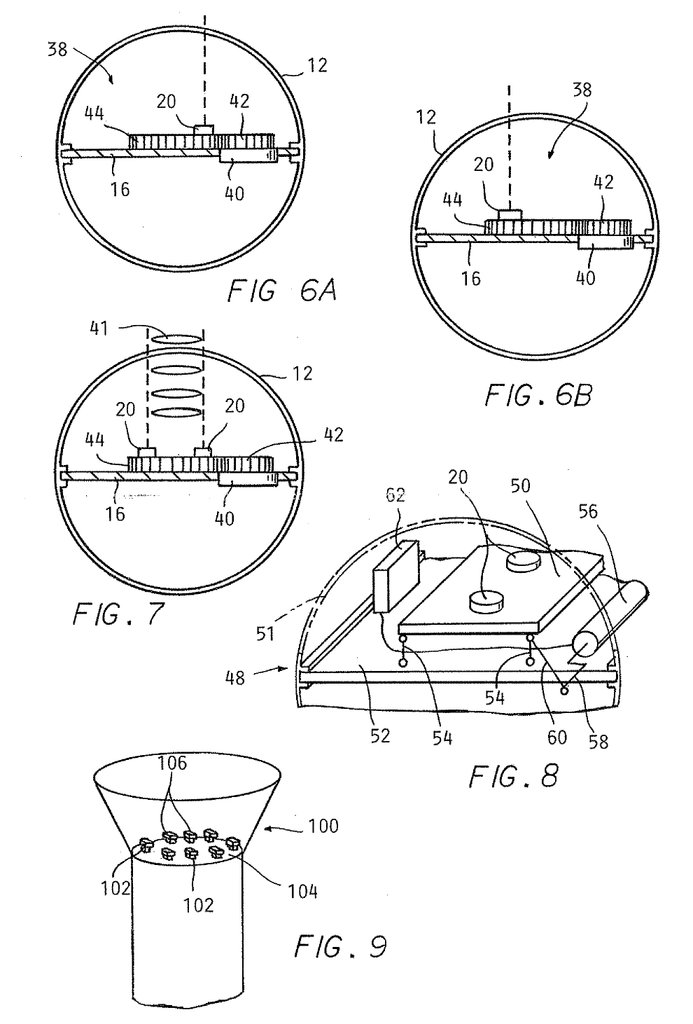

An oscillator other than the MEMS 18 can be used. For example, FIG. 5 shows a MEMS 38 including a motor 40 attached to an aperture defined by the circuit board 16, a pinion gear 42 coupled to the motor 40, a spur gear 44 meshed with the pinion gear 42, and an LED 20 in a first position and a phantom LED 20 in a second position attached to the spur gear 44. Operating the motor 40 can cause the pinion gear 42 to rotate, which in turn can cause the spur gear 44 to rotate. Rotation of the spur gear 44 can move the LED 20 in a circular pattern, with the first and second positions of the LED 20 shown in FIGS. 6A and 6B. The MEMS 38 can cause the LED 20 to appear as a circular source of light as shown by a circular line 41 in FIG. 7 instead of a point source of light.

Alternatively, structures other than microelectromechanical systems can be used as oscillators. For example, FIG. 8 shows a light 48 including a circuit board 50 pivotally mounted by a pair of levers 54 to a support 52 slidably engaged with a housing 51. Multiple LEDs 20 can be mounted on the circuit board 50. A motor 56 can be attached to the support 52, and a cam 58 can be coupled to the motor 56. The cam 58 can be coupled to the circuit board 50 by a link 60. Operation of the motor 56 can rotate the cam 58, and the link 60 can transmit motion from the cam 58 to the circuit board 50. As a result, the entire circuit board 50, as well as the LEDs 20 mounted thereon, can be oscillated. The motor 56 can be operated to rotate at a sufficient speed that the LEDs 20 move fast enough to produce a light blurring effect. Also, the levers 54, motor 56, cam 58, and link 60 can be large enough that they are not considered MEMS. For example, the motor 56 can be substantially larger than one of the LEDs 20.

Additionally, the light 48 in FIG. 8 can include a controller 62. The controller 62 can be in electrical communication the motor 56, and it can also be in electrical communication with a power source, such as the end caps 22. The controller 62 can control the rotational speed of the motor 56 by governing the current supplied to the motor 56. As a result, the controller 62 can control an oscillation frequency of the LEDs 20, which can alter the appearance of the light produced by the LEDs 20. The controller 62 can include a CPU and memory, and operation of the controller 62 can be controlled by a switch on the light 48, remotely, or internally by a program stored on the memory. Additionally, the controller 62 can be in communication with the LEDs 20 to vary the output of the LEDs 20 during operation, for example.

While the above described embodiments illustrate the use of oscillators in lights shaped to replace fluorescent tubes, LEDs can also be mounted on oscillators in other types of light, such as vehicle lights, table lights, street lights, and lights designed to replace incandescent bulbs. As a further example, FIG. 9 illustrates a flashlight 100 including multiple MEMS 102 mounted on a base plate 104. The base plate 104 can be any type of support structure, for example a plastic piece beneath a lens of the flashlight 100. An LED 106 can be connected to each MEMS 102. The MEMS 102 can oscillate the LEDs 106, either by rotating the LEDs 106, translating the LED 106, moving the LEDs 106 using a combination of translation and rotation, moving a support structure to which all the LEDs 106 are connected, or otherwise moving the LEDs 106, in order to produce a light blurring effect. As a result, the flashlight 100 can produce light with a wide viewing angle.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. An LED-based light comprising:
a support structure;
at least one oscillator connected to the support structure; and
at least one LED coupled to each oscillator.

2. The LED-based light of claim 1, wherein each oscillator includes a microelectromechanical system operative in response to a current to move the at least one LED between a first position and a second position.

3. The LED-based light of claim 1, wherein each oscillator is operative in response to a current to move at least one LED continuously between a first position and a second position during operation of the at least one LED.

4. The LED-based light of claim 3, wherein the first position is at an angle to the second position.

5. The LED-based light of claim 1, further comprising:
a circuit board connected to the at least one oscillator for movement of the circuit board relative to the support structure, and wherein the at least one LED is mounted on the circuit board for movement with the support structure between a first position and a second position.

6. The LED-based light of claim 1, further comprising:
a tubular housing; and
two pin-carrying end caps connected to opposing ends of the housing, with at least one of the end caps in electrical communication with the LEDs; and
wherein the support structure includes a circuit board positioned in the tubular housing.

7. The LED-based light of claim 6 wherein at least one of the pin-carrying end caps is in electrical communication with the at least one oscillator.

8. A replacement light for a conventional fluorescent tube usable in a fluorescent fixture comprising:
a support structure;
at least one oscillator connected to the support structure;
at least one LED coupled to each oscillator; and
at least one electrical connector at a longitudinal end of the support structure in electrical communication with the at least one LED.

9. The LED-based light of claim 8, wherein each oscillator includes a microelectromechanical system operative in response to a current to move at least one LED between a first position and a second position.

10. The LED-based light of claim 8, wherein each oscillator is operative in response to a current to move at least one LED continuously between a first position and a second position during operation of the at least one LED.

11. The LED-based light of claim 10, wherein the first position is at an angle to the second position.

12. The LED-based light of claim 8, further comprising:
a circuit board connected to the at least one oscillator for movement relative to the support structure, and wherein the at least one LED is mounted on the circuit board for movement with the support structure between a first position and a second position.

13. The LED-based light of claim 8, wherein the at least one electrical connector is further in electrical communication with each oscillator.

14. The LED-based light of claim 8, wherein the support structure includes a circuit board; and wherein the at least one electrical connector includes a pair of pin-carrying end caps.

15. A method of distributing light produced by LEDs in an LED-based light usable in a fluorescent fixture, the method comprising:
providing at least one microelectromechanical system;
connecting the LEDs to the least one microelectromechanical system; and
energizing the at least one microelectromechanical system during operation of the LEDs to move the LEDs at a sufficient speed to produce a light blurring effect.

16. The method of claim 15, further comprising continuously moving the LEDs during their operation.

17. The method of claim 15, further comprising changing the angle of orientation of the LEDs during their operation.

18. The method of claim 15, further comprising powering the at least one microelectromechanical system and the LEDs with a common power source.

19. The method of claim 15, further comprising providing a controller configured to vary an oscillation frequency of the at least one microelectromechanical system.

20. The method of claim 15, further comprising providing a microelectromechanical motor configured to drive the microelectromechanical system.
